(19) United States
(12) Patent Application Publication
(10) Pub. No.: US 2014/0351255 A1
(43) Pub. Date: Nov. 27, 2014

(54) METHOD AND SYSTEM FOR RECOMMENDING KEYWORD BASED ON SEMANTIC AREA

(71) Applicant: NAVER Corporation, Seongnam-si (KR)

(72) Inventors: Jae Ho Choi, Seongnam-si (KR); Jae Keol Choi, Seongnam-si (KR); Kwang Hyun Kim, Seongnam-si (KR)

(21) Appl. No.: 14/453,215

(22) Filed: Aug. 6, 2014

(30) Foreign Application Priority Data
Aug. 7, 2012 (KR) 10-2013-0093749

(51) Int. Cl. G06F 17/30

(52) U.S. Cl. CPC G06F 17/3097
USPC 707/739; 707/759; 707/748

(57) ABSTRACT

A method of recommending a keyword includes redefining a semantic area using a search log including location information, and providing a keyword associated with the semantic area to a user located in the semantic area as a recommended keyword.

### CROSS-REFERENCE TO RELATED APPLICATION

This application claims priority from and the benefit of Korean Patent Application No. 10-2013-0093749, filed on Aug. 7, 2013, which is hereby incorporated by reference for all purposes as if fully set forth herein.

### BACKGROUND

Example embodiments relate to a keyword recommendation method and system optimized for a mobile search environment.

With the recent development in information technology, a user may connect to the Internet at any time and any place, and accordingly, may search for information without restrictions on time and space and may use desired contents and services.

Further, the development in mobile communication technology has significantly increased the spread of mobile terminals, for example, mobile phones, smartphones, and personal digital assistants (PDAs). Accordingly, mobile search users searching for information using mobile terminals are surprisingly increasing.

In general, a search engine may provide a service for recommending a keyword for search convenience of a user. For example, Korean Registration Patent No. 10-0964090 discloses technology for recommending a keyword using a variety of log information.

However, due to the characteristics of a mobile search, the mobile search, in many cases, may be associated with an area at which a user is located or a lifestyle of the user compared to a personal computer (PC)-based search. A keyword recommendation system of the existing search engine may not sufficiently recommend a keyword based on a mobile characteristic.

### SUMMARY

Example embodiments provide a keyword recommendation method and system that may redefine a physical area division semantically instead of using an administrative district and may recommend a keyword based on the semantically redefined physical area division.

Example embodiments also provide a keyword recommendation method and system suitable for a mobile search environment based on a character of place and a character of time.

Additional features of the example embodiments will be set forth in the description which follows, and in part will be apparent from the description, or may be learned by practice of the example embodiments.

Example embodiments disclose a method of recommending a keyword, the method including redefining a semantic area using a search log including location information, and providing a keyword associated with the semantic area to a user located in the semantic area as a recommended keyword.

The redefining of the semantic area may include classifying the semantic area by clustering the location information based on a keyword included in the search log.

The keyword recommendation method may further include identifying a local keyword indicating a character of place of the semantic area. Providing the keyword may include providing the local keyword as the recommended keyword to the user located in the semantic area.

The identifying of the local keyword may include identifying the local keyword from the search log retrieved from the semantic area.

The keyword recommendation method may further include analyzing the use distribution of keywords used for search in the semantic area, based on each time section. Providing the recommended keyword may include providing, as recommended keywords, keywords distributed in a time section corresponding to an access time of the user.

The analyzing of the use distribution may include analyzing the use distribution of keywords used for search in the semantic area for each of at least one time section of each day of the week and each time zone of a day.

Providing the recommended keyword may include ranking and providing keywords used for search in the semantic area.

Providing the recommended keyword may include classifying keywords used for search in the semantic area into categories, and ranking and providing the categories and category-based keywords.

Example embodiments also include a method of recommending a keyword, the method including redefining a semantic area using a search log including location information; identifying a local keyword indicating a character of place of the semantic area, analyzing the use distribution of the local keyword based on each time section, and providing, to a user located in the semantic area as a recommended keyword, a keyword distributed in a time section corresponding to an access time of the user among local keywords of the semantic area.

Example embodiments also include a method of recommending a keyword, the method including transmitting a keyword recommendation request and a current location to a search server, and displaying a recommended keyword provided from the search server in response to the keyword recommendation request. Here, the search server may redefine a semantic area using a search log including location information, and may provide a keyword associated with the semantic area including the current location as the recommended keyword.

Example embodiments also include a system for recommending a keyword, the system including a definer configured to redefine a semantic area using a search log including location information, and a provider configured to provide a keyword associated with the semantic area to a user located in the semantic area as a recommended keyword.

It is to be understood that both the foregoing general description and the following detailed description are explanatory and are intended to provide further explanation of the example embodiments as claimed.

According to example embodiments, it is possible to more accurately and precisely recommend an area-based keyword by redefining a physical area division semantically instead of using an administrative district or an area within a predetermined radius and by using the semantically redefined physical area division.

Also, according to example embodiments, it is possible to recommend a keyword appropriate for the current time and the location of a user by recommending a keyword based on a new standard in which a character of place and a character of time are applied. Accordingly, it is possible to further enhance the convenience of a mobile search and a search environment.

### BRIEF DESCRIPTION OF THE DRAWINGS

The accompanying drawings, which are included to provide further understanding of the example embodiments and are incorporated in and constitute a part of this specification, illustrate example embodiments, and together with the description serve to explain the principles of the example embodiments.

FIG. 1 illustrates a relationship between a mobile device and a keyword recommendation system according to an example embodiment.

FIG. 2 is a flowchart illustrating a keyword recommendation method for recommending a keyword based on a semantic area according to an example embodiment.

FIG. 3 illustrates an example of semantic area clusters according to one example embodiment.

FIG. 4 is a graph showing an example of a statistical distribution of keywords having a characteristic for each semantic area according to an example embodiment.

FIG. 5 is a table illustrating an example of character-of-place keywords for each semantic area according to one example embodiment.

FIG. 6 is a graph showing an example of a distribution of keywords used for search in a predetermined area based on each time zone according to one example embodiment.

FIG. 7 illustrates an example of a recommended keyword list displayed on a search screen of a mobile device according to an example embodiment.

FIG. 8 is a block diagram illustrating a configuration of a keyword recommendation system for recommending a keyword based on a semantic area according to an example embodiment.

### DETAILED DESCRIPTION OF EXAMPLE EMBODIMENTS

The invention is described more fully hereinafter with reference to the accompanying drawings, in which example embodiments are shown. This invention may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and areas may be exaggerated for clarity. Like reference numerals in the drawings denote like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described with reference to the accompanying drawings.

The example embodiments may be applied to a search engine system for providing a search environment. In particular, the example embodiments may be applied to a keyword recommendation system that may provide a service for recommending a keyword, for example, a recent issuing keyword and a related keyword associated with a keyword input from a user, for search convenience of the user.

The example embodiments may relate to providing a query as a recommendation target instead of providing content, and may relate to providing a recommendation service specialized for the query.

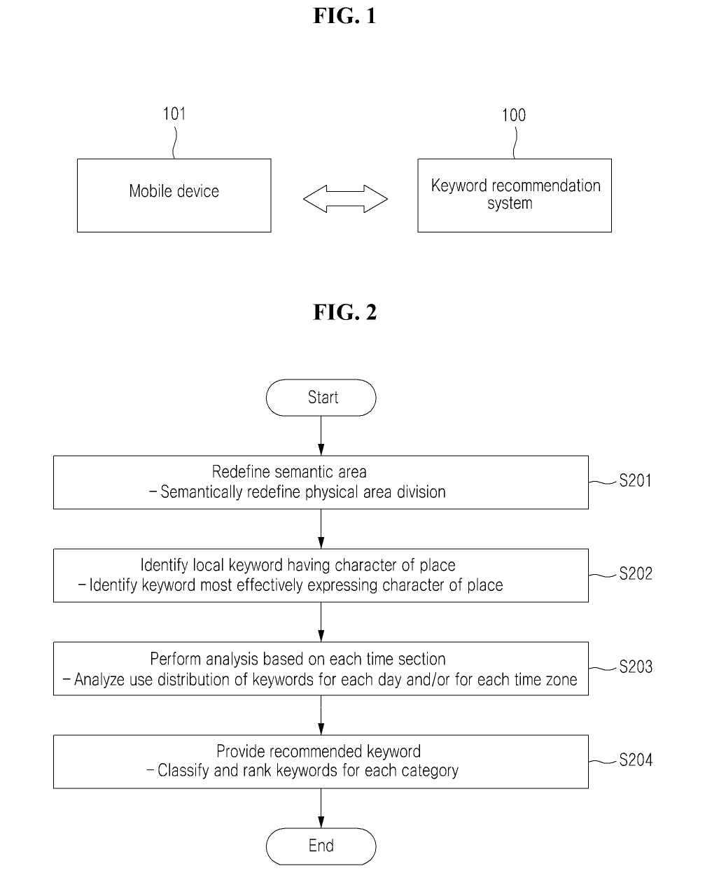

FIG. 1 illustrates a relationship between a mobile device 101 and a keyword recommendation system 100 according to example embodiments. Here, an arrow indicator indicates that data may be transmitted and received between the mobile device 101 and the keyword recommendation system 100 over a wireless network.

The keyword recommendation system 100 serves as a service platform configured to provide a mobile search environment to the mobile device 101 corresponding to a client. In particular, the keyword recommendation system 100 provides a service for recommending a keyword in a mobile web or a mobile application (app) through a service platform based on a mobile search.

The mobile device 101 may refer to any type of terminal devices accessible to the keyword recommendation system 100 through a mobile web or a mobile app, for example, a smartphone, a tablet, a laptop computer, a digital multimedia broadcasting (DMB) terminal, a portable multimedia player (PMP), and a navigation terminal Here, the mobile device 101 performs the overall service operation, for example, a service screen configuration, a data input, a data transmission and reception, and a data storage according to a control of the mobile web or the mobile app.

A mobile search using the mobile device 101 may be further closely associated with our life compared to a personal computer (PC)-based search. For example, employee Mr. A may start a day by waking up in the morning, verifying “today's weather” through search, and searching for a timetable of “No. OO bus” to go to the office. When it comes to lunch time, Mr. A may search for a nearby restaurant using “famous restaurant at OO-dong”. Also, Mr. A may finish a day by searching for a title of a program on air on television after work and before going to bed. The above search pattern may be applied to a predetermined location or place as well as an individual. In particular, search acts using ubiquitous mobile devices of individual users may be actively conducted at a location, for example, a station influence area, an area around a university, and a tourist site, at which a large number of people gather. The search acts may be conducted in large scale and in various manners, and may create big data having a relatively high utilization.

According to the example embodiments, it is possible to predict a keyword to be input from a search user at a predetermined location and a predetermined time, based on big data collected from the search pattern and search acts through the mobile device 101, and to provide a user-targeted keyword recommendation service.

Also, according to the example embodiments, to overcome the issue that a keyword input may be difficult due to a limited size of a screen and a keyboard, the mobile device 101 may recommend an appropriate keyword based on a predetermined location and a predetermined time. Accordingly, a user may conduct a search immediately only with a selection on a recommended keyword without a need to input a keyword. In an example in which the user conducts a search at Gangnam station at 7:00 PM, it is possible to provide the convenience in selecting a query based on user activity and needs by presenting queries frequently input from other users at Gangnam station at 7:00 PM in the past.

Accordingly, the present specification proposes a localized-temporal personalization system (LTPS)-based keyword recommendation service capable of recommending a personalized keyword to a user based on location and time, as a new keyword recommendation model appropriate for a mobile era.

In the present specification, “conduct a search” may indicate executing a mobile web or a mobile app for a search in a mobile device or may indicate that a cursor is displayed on an input window for inputting a keyword on a service screen of the mobile web or the mobile app.

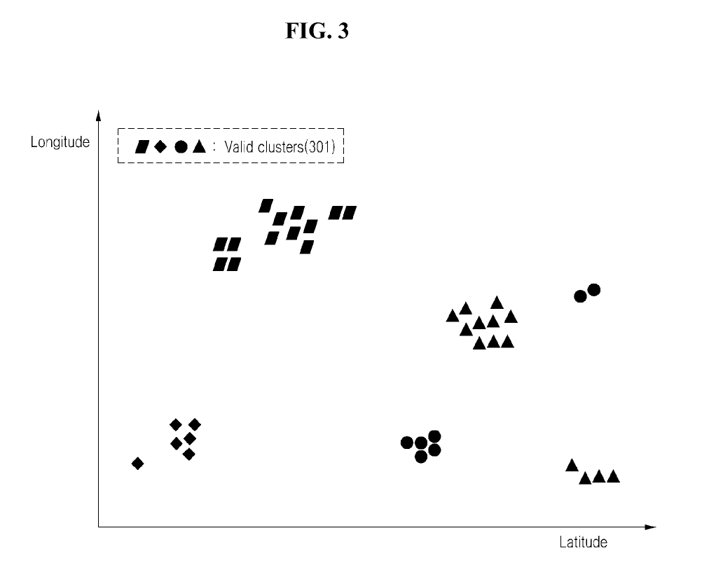

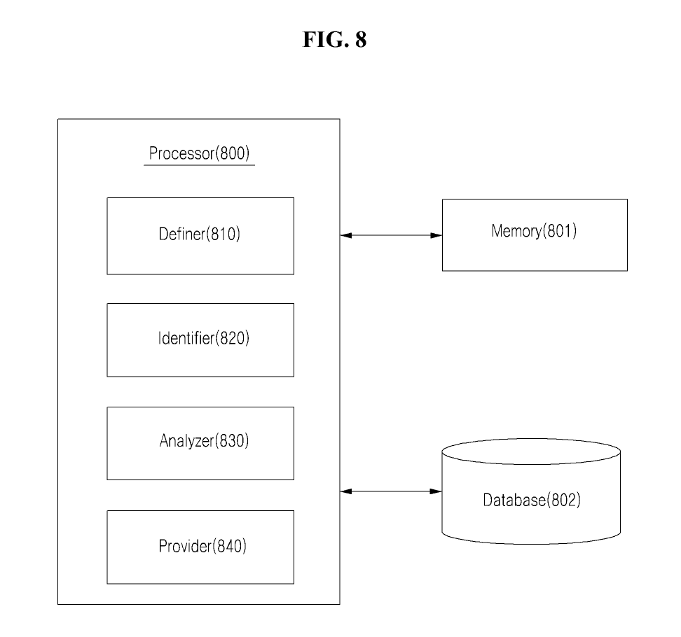

FIG. 2 is a flowchart illustrating a keyword recommendation method for recommending a keyword based on a semantic area according to one example embodiment. The semantic area may be a virtual area generated based on a separate criterion unrelated to an administration unit. Operations of the keyword recommendation method of FIG. 2 may be performed by a keyword recommendation system 100 described with reference to FIGS. 1 and 8.

In operation S201, the keyword recommendation system 100 redefines a physical area division semantically instead of using an administrative district. The administrative district may be a district defined for administrative purposes by government. To handle data based on a physical area, the keyword recommendation system 100 separately redefines and use a semantic area instead of using existing administrative district information or global positioning system (GPS) location information obtained by a mobile device 101.

The keyword recommendation system 100 may redefine the semantic area using a search log including location information. To this end, the keyword recommendation system 100 collects search logs using the mobile device 101, and uses a search log including log information among the collected search logs. For example, a data format of a mobile search log may be expressed by the following Table 1. For reference, the same user may be identified using a unique B cookie value.

TABLE 1

| Search | | | |
|---|---|---|---|
| time | Query | B cookie | Location |
| 1361176167 | Gangnam | EDYVYLEV5SOU6 | 37.500,127.026 |
| | restaurant | | |
| 1361180288 | Yeouido A | VKCRGH4BR37FA | 37.561,127.067 |
| | buffet | | |
| 1361180300 | Price at | VKCRGH4BR37FA | 37.561,127.067 |
| | Yeouido A | | |
| | buffet | | |
| . . . | . . . | . . . | . . . |

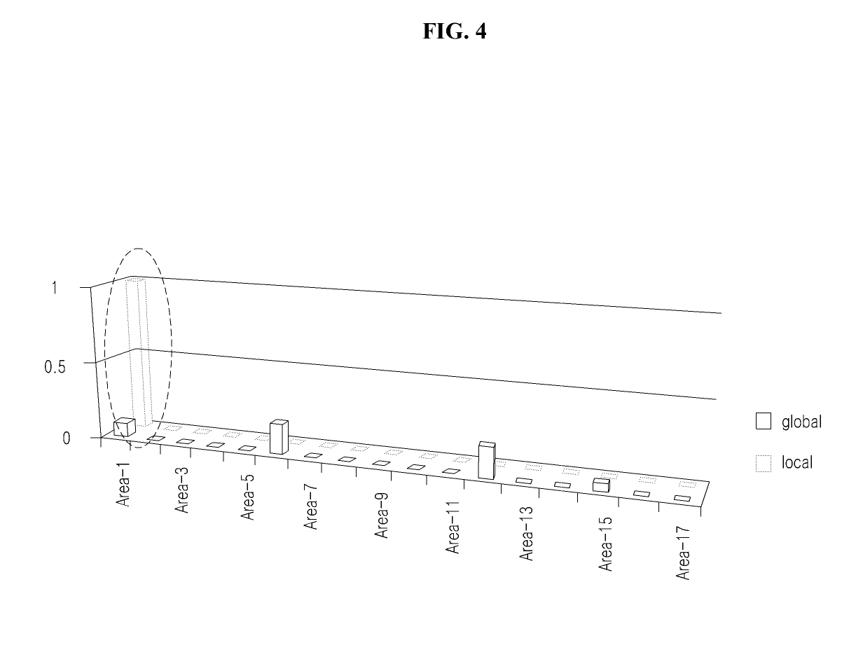

The keyword recommendation system 100 may automatically classify a semantic area based on a density-based clustering algorithm, and may periodically update the semantic area based on user data, for example, a search log. As an example, the keyword recommendation system 100 may classify a semantic area by clustering location information based on a keyword, for example, a query included in a search log. For example, referring to FIG. 3, when a location at which one hundred or more B cookies are present is defined as a valid cluster 301, the keyword recommendation system 100 may redefine the semantic area by clustering valid clusters 301 in which the same keyword is present. As illustrated in FIG. 3, the valid clusters 301 indicating the semantic area may appear as different points.

Referring again to FIG. 2, in operation S202, the keyword recommendation system 100 identifies a local keyword corresponding to a keyword indicating a character of place of the redefined semantic area. As an example, the keyword recommendation system 100 may identify a local keyword from a search log retrieved from a semantic area. That is, the keyword recommendation system 100 may identify a keyword most effectively expressing a character of place from data obtained by users using mobile devices 101 from a corresponding area. Such character-of-place keywords may be identified using basic data and recommendation technology accumulated through a plurality of services for recommending a keyword, for example, a related keyword and a popular keyword.

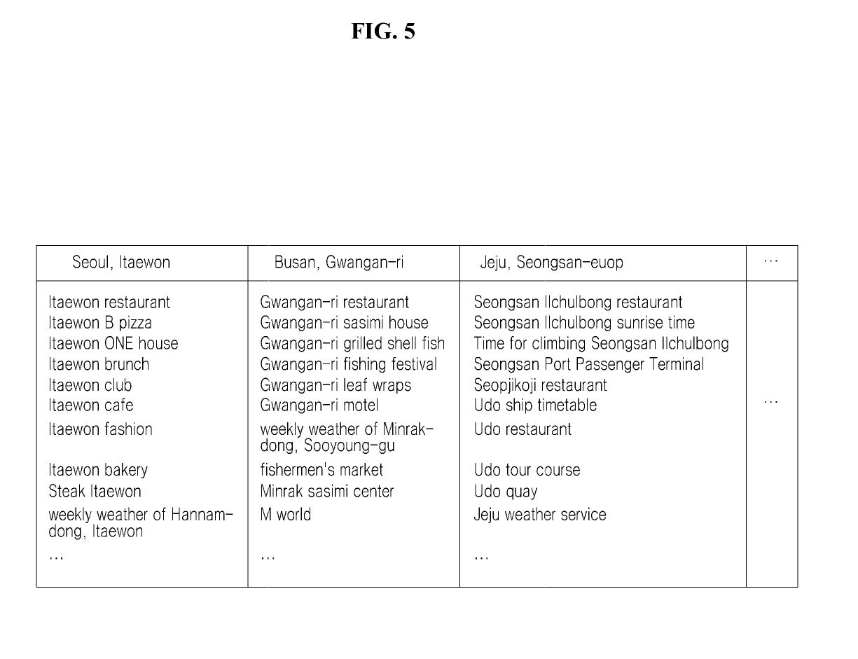

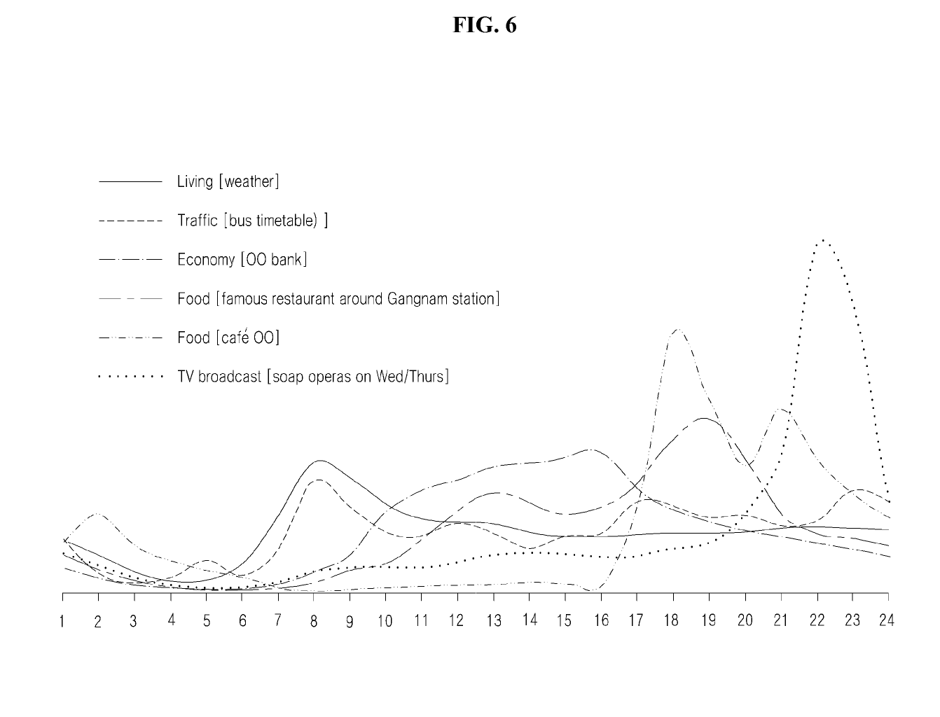

For example, FIG. 4 illustrates a statistical distribution of the number of searches for each semantic are redefined with respect to keyword “Busan No. 77 bus”. That is, the keyword “Busan No. 77 bus” may be selected as a local keyword of “Area-1”. Accordingly, the keyword recommendation system 100 may identify, as a local keyword having a character of place, a keyword used for search at least a predetermined number of times, based on statistics for each area. A table of FIG. 5 shows an example of a local keyword for each semantic area selected using the same method.

Referring again to FIG. 2, in operation S203, the keyword recommendation system 100 analyzes the use distribution of keywords used for search in the redefined semantic area, based on each time section. The keyword recommendation system 100 may employ, as an important factor, the time in which a search is conducted as well as the location of a user using a mobile device. Although it is the same location, a search pattern of a user may vary based on the day, for example, Monday or Saturday, or the time zone, for example, 8:00 AM or 1:00 PM. As an example, the keyword recommendation system 100 may analyze the use distribution of keywords for each of at least one time section of each day of the week and each time zone of one day.

FIG. 6 is a graph showing an example of a distribution of keywords used for searches in an area around Gangnam station based on each time zone. Referring to FIG. 6, it can be known that a search time zone differs for each keyword. For example, it can be known that keywords “weather” and “bus timetable” are most frequently used for searches in a morning time zone, for example, between 7:00 AM and 9:00 AM. Also, keywords “famous restaurants around Gangnam station” is most frequently used for searches in a lunch time zone, for example, between 12:00 AM and 2:00 PM and in an evening time zone, for example, between 5:00 PM and 8:00 PM. On the other hand, “OO café” is most frequently used for search in a dinner time zone, for example, between 6:00 PM and 7:00 PM and in a night time zone, for example, in 9:00 PM. Based on the distribution of keywords, the keyword recommendation system may predict a keyword that is relatively frequently used at a predetermined point in time, and provides an optimized recommendation result by analyzing the use distribution of keywords input from users based on each day and/or on each time zone.

Referring again to FIG. 2, in operation S204, the keyword recommendation system 100 provides a recommended keyword to a user having conducted a search based on the redefined semantic area. As an example, the keyword recommendation system 100 may provide, as a recommended keyword, a keyword associated with a semantic area corresponding to the current location of the user obtained from a mobile device 101. The keyword recommendation system 100 may redefine the semantic area based on a keyword included in a mobile search log. Accordingly, the keyword recommendation system 100 may recommend a keyword most frequently used in the semantic area in which the user is located, regardless of an administrative district or a predetermined radius in which the user is located. The same keyword may be recommended to users located in the same valid cluster.

When users are located in the same administrative district or the predetermined radius, however, each of the users belongs to a different valid cluster, different keywords may be recommended to users, respectively. For example, a user located in Exit No. 9 of Gangnam station and a user located in Exit No. 11 of Gangnam station may be provided with different recommended keywords, respectively.

As another example, the recommended keyword system 100 may provide, as a recommended keyword, a local keyword identified as a keyword most effectively expressing a character of place of a corresponding area from among keywords previously used for search in the semantic area in which a user is currently located.

As another example, the recommended keyword system 100 may provide, as a recommended keyword, a keyword distributed in a time zone corresponding to an access time of a user among keywords previously used for search in the semantic area in which the user is currently located.

As another example, the keyword recommendation system 100 may recommend an appropriate keyword into consideration of a current location and an access time of a user based on a redefined semantic area. That is, the keyword recommendation system may verify the current location and the access time of the user and then may verify the semantic area in which the user is currently located, and may recommend a keyword verified to be frequently used for search in the access time of the user among local keywords having a character of place of a corresponding area.

Further, the keyword recommendation system 100 may rank and provide recommended keywords optimized for a location and a time of a user. As an example, the keyword recommendation system may rank and provide keywords previously used for search in a semantic area in which a user is currently located. As another example, the keyword recommendation system 100 may classify, into categories, keywords previously used for search in a semantic area in which a user is currently located and then may rank and provide the categories and category-based keywords. That is, the keyword recommendation system 100 may include a ranking model configured to rank, for each category and/or each keyword, recommended keywords optimized for a location and a time of the user. For example, with respect to categories, such as traffic (subway map, OO terminal timetable, and OO bus timetable), restaurants (OO restaurant and OO pizza), living/economy (weather, foreign currency, and lottery) and keywords, the categories may be ranked in order of “living/economy>traffic>restaurants” in the morning, and may be ranked in order of “restaurants >traffic>living/economy” in a lunch time. In addition, it is possible to maximize the convenience in inputting a keyword by preferentially displaying a relatively more appropriate keyword within a single category.

The aforementioned keyword recommendation method redefines a physical area division semantically instead of using an administrative district and recommends a keyword based on the redefined semantic area. Further, the keyword recommendation method recommends a keyword optimized for the location and the time of search of a mobile search user.

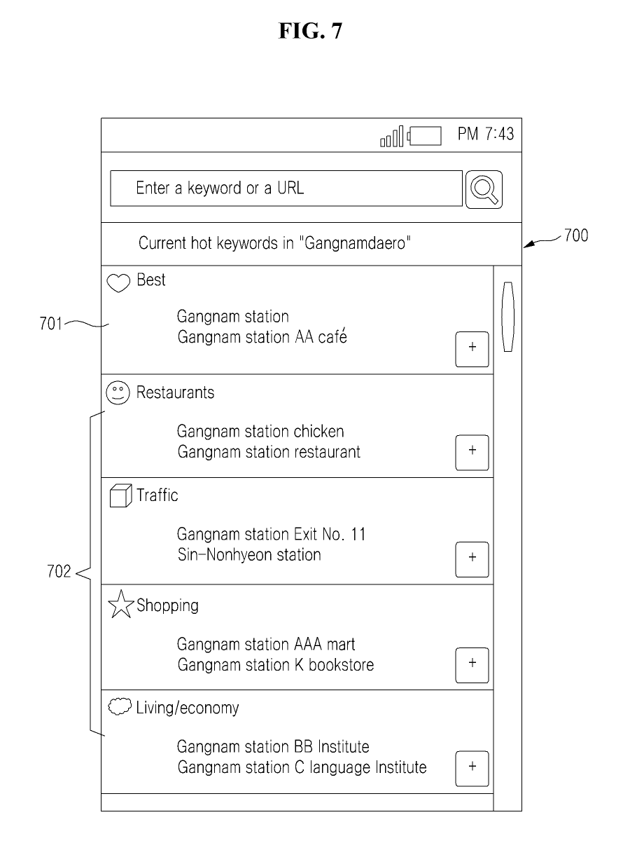

Meanwhile, a mobile device 101 may transmit a keyword recommendation request and a current location to the keyword recommendation system 100 corresponding to a search server in response to a search of the user. Accordingly, the mobile device 101 may display a recommended keyword provided from the keyword recommendation system 100 in response to the keyword recommendation request. FIG. 7 illustrates an example of a search screen 700 of a mobile device 101 on which a recommended keyword list is displayed according to one example embodiment, and illustrates an example of categories and keywords displayed in a dinner time zone, for example, between 6:00 PM and 7:00 PM around Gangnam station. For example, simple keyword rankings 701 and category-based rankings 702 including rankings of keywords for each category may be displayed on the search screen 700 with respect to keywords previously used for search in a semantic area corresponding to the current location of a user. Here, the mobile device 101 may be provided with a location-and-time-based keyword recommendation service from the keyword recommendation system 100. Rankings of categories and keywords to be displayed may vary based on the location and the time at which a search is conducted.

The methods according to the example embodiments may be performed through a variety of computer systems and may be recorded in non-transitory computer-readable media in a program instruction form. In particular, the example embodiments may include non-transitory computer-readable media storing a program that includes redefining a semantic area using a search log including location information, and providing a keyword associated with the semantic area to a user located in the semantic area as a recommended keyword.

The program according to the example embodiments may include a PC-based program or an application exclusive for a mobile terminal An app for a mobile search may be configured in an independently operating program form or an in-app form of a predetermined application to thereby be operable on the predetermined application.

The keyword recommendation method according to the example embodiments may be performed in such a manner that a mobile app associated with a server system, for example, the keyword recommendation system, controls a user terminal For example, the application may include modules configured to control the user terminal to perform operations included in the aforementioned keyword recommendation method. As an example, the application may include a module configured to control the user terminal to transmit a keyword recommendation request and a current location to a search server, and a module configured to control the user terminal to display a recommended keyword provided from the search server in response to the keyword recommendation request. Also, the application may be installed in the user terminal through a file provided from a file distribution system. For example, the file distribution system may include a file transmitter (not shown) configured to transmit the file in response to a request of the user terminal

FIG. 8 is a block diagram illustrating a configuration of a keyword recommendation system 100 for recommending a keyword based on a semantic area according to an exemplary embodiment of the present invention. Referring to FIG. 8, the keyword recommendation system 100 includes a processor 800 performing the functions of a definer 810, an identifier 820, an analyzer 830 and a provider 840; a memory 801, and a database 802.

A program including an instruction to redefine a semantic area using a search log including location information and to provide a keyword associated with the semantic area as a recommended keyword to a user located in the redefined semantic area may be stored in the memory 801. Operations performed by the keyword recommendation system 100 described above with reference to FIGS. 1 through 7 may be executed by the program stored in the memory 801. For example, the memory 801 may be a hard disc, a solid state disk (SSD), a secure digital (SD) card, and other storage media.

The database 802 refers to a storage capable of storing and managing any type of information required to provide a keyword recommendation service. Mobile search log data, location information corresponding to a semantic area, a local keyword for each local keyword, and distribution time information for each keyword may be stored in the database 802.

In an exemplary embodiment, the processor 800 is a computing device configured to perform processing in response to the instructions of the program stored in the memory 801, and may include a microprocessor, for example, a central processing unit (CPU), a controller, an arithmetic logic unit, a digital signal processor or any other devices capable of responding to the executing instructions in a defined manner. The four different units or modules of the processor 800, i.e., the definer 810, the identifier 820, the analyzer 830 and the provider 840 correspond to the four different functions performed by the processor based on the program instructions stored in the memory 801. Hereinafter, a detailed configuration of the processor 800 will be described.

To redefine a physical area division semantically instead of using an administrative district, the definer 810 collects search logs using a mobile device and classifies the semantic area using a search log including location information. As an example, the definer 810 may automatically classify a semantic area based on a density-based clustering algorithm, and may classify the semantic area by clustering location information based on a keyword included in a search log. The definer 810 may periodically update the semantic area based on a mobile search log.

The identifier 820 identifies a local keyword corresponding to a keyword indicating a character of place of the redefined semantic area. As an example, the identifier 820 may identify, as a local keyword most effectively expressing a character of place of a corresponding area, a keyword used for search at least a predetermined number of times based on statistics for each area of a keyword, using a search log retrieved from the semantic area.

The analyzer 830 analyzes the use distribution of keywords used for search in the redefined semantic area, based on each time section. As an example, the analyzer 830 may analyze the use distribution of keywords for each of at least one time section of each day of the week and each time zone of a day. That is, the analyzer 830 may analyze the use distribution of keywords input from users based on each day and/or each time zone, and may predict a keyword relatively frequently used at a predetermined point in time in order to provide a recommended keyword optimized for a time.

The provider 840 provides a recommended keyword to a user having conducted a search, based on the redefined semantic area. As an example, the provider 840 may provide a keyword associated with a semantic area corresponding to a current location of a user as a recommended keyword, based on the current location of the user obtained from a mobile device. As another example, the provider 840 may provide, as a recommended keyword, a local keyword identified as a keyword most effectively expressing a character of place of a corresponding area from among keywords previously used for search in the semantic area in which the user is currently located. As another example, the provider 840 may provide, as a recommended keyword, a keyword distributed in a time zone corresponding to the access time of a user among keywords previously used for search in the semantic area in which the user is currently located. As another example, the provider 840 may recommend an appropriate keyword into consideration of the current location and the access time of a user based on a redefined semantic area. That is, the provider 840 verifies the current location and the access time of the user and then verifies the semantic area in which the user is currently located, and recommends a keyword verified to be frequently used for search in the access time of the user among local keywords having a character of place of a corresponding area.

In particular, the provider 840 ranks and provides recommended keywords optimized for the location and the access time of a user. As an example, the provider 840 may rank and provide keywords previously used for search in a semantic area in which a user is currently located. As another example, the provider 840 may classify, into categories, keywords previously used for search in a semantic area in which a user is currently located and then may rank and provide the categories and category-based keywords. That is, the provider 840 may include a ranking model configured to rank, for each category and/or each keyword, recommended keywords optimized for a location and a time of the user (see FIG. 7).

The keyword recommendation system 100 configured as above recommends a keyword based on a redefined semantic area and, in this instance, recommends a keyword optimized for the location and the access time of a mobile search user.

The keyword recommendation system 100 may omit a portion of constituent elements or may further include additional constituent elements based on the detailed description of the keyword recommendation method described above with reference to FIGS. 1 through 7. Also, at least two constituent elements may be combined and operation orders or methods between constituent elements may be modified.

As described above, according to example embodiments, it is possible to more accurately and precisely recommend an area-based keyword by redefining a physical area division semantically instead of using an administrative district or an area within a predetermined radius, and by using the semantically redefined physical area division. Also, according to example embodiments, it is possible to recommend a keyword appropriate for the current time and the location of a user by recommending a keyword based on a new standard in which a character of place and a character of time are applied. Accordingly, it is possible to further enhance the convenience of a mobile search and a search environment.

The program stored in the memory 801 for providing the keyword recommendation may also be recorded in non-transitory computer-readable media. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. A method of recommending a keyword, comprising:
redefining, by a processor, a semantic area using a search log stored in a database including location information; and
providing, by the processor, a keyword associated with the semantic area to a mobile device of a user located in the semantic area as a recommended keyword.

2. The method of claim 1, wherein the redefining of the semantic area comprises classifying the semantic area by clustering the location information based on a keyword included in the search log.

3. The method of claim 1, further comprising:
identifying a local keyword indicating a character of place of the semantic area,
wherein the providing the keyword comprises providing the local keyword as the recommended keyword to the user located in the semantic area.

4. The method of claim 3, wherein the identifying the local keyword comprises identifying the local keyword from the search log retrieved from the semantic area.

5. The method of claim 1, further comprising:
analyzing a use distribution of keywords used for search in the semantic area, based on each time section,
wherein the providing the recommended keyword comprises providing, as recommended keywords, keywords distributed in a time section corresponding to an access time of the user.

6. The method of claim 5, wherein the analyzing the use distribution comprises analyzing the use distribution of keywords used for search in the semantic area for each of at least one time section of each day of the week and each time zone of a day.

7. The method of claim 1, wherein the providing the recommended keyword comprises ranking and providing keywords used for search in the semantic area.

8. The method of claim 1, wherein the providing the recommended keyword comprises classifying keywords used for search in the semantic area into categories, and ranking and providing the categories and category-based keywords.

9. A method of recommending a keyword, comprising:
redefining, by a processor, the semantic area using a search log including location information;
identifying, by the processor, the local keyword indicating a character of place of the semantic area;
analyzing, by the processor, a use distribution of the local keyword based on each time section; and
providing, by the processor, to a user located in the semantic area as a recommended keyword, a keyword distributed in a time section corresponding to an access time of the user among local keywords of the semantic area.

10. The method of claim 9, wherein the providing the recommended keyword comprises classifying, into categories, local keywords used for search in the semantic area at which the user is located, and ranking and providing the categories and category-based keywords.

11. A method of recommending a keyword, comprising:
Transmitting, by a mobile device, a keyword recommendation request and a current location to a search server; and
Displaying, on the mobile device, a recommended keyword provided from the search server in response to the keyword recommendation request,
wherein the search server redefines a semantic area using a search log including location information, and provides a keyword associated with the semantic area comprising the current location as the recommended keyword.

12. The method of claim 11, wherein the search server classifies, into categories, keywords used for search in the semantic area comprising the current location, and ranks and provides the categories and category-based keywords.

13. A system for recommending a keyword, comprising:
a processor;
a memory storing a program having instructions for performing a plurality of functions, the functions including,
a definer configured to redefine a semantic area using a search log comprising location information; and
a provider configured to provide a keyword associated with the semantic area to a user located in the semantic area as a recommended keyword.

14. The system of claim 13, wherein the definer is configured to classify the semantic area by clustering the location information based on a keyword comprised in the search log.

15. The system of claim 13, wherein the plurality of functions further comprises:
an identifier configured to identify a local keyword indicating a character of place of the semantic area,
wherein the provider is configured to provide the local keyword as the recommended keyword to the user located in the semantic area.

16. The system of claim 15, wherein the identifier is configured to identify the local keyword from the search log retrieved from the semantic area.

17. The system of claim 13, wherein the plurality of functions further comprises:
an analyzer configured to analyze the use distribution of keywords used for search in the semantic area, based on each time section,
wherein the provider is configured to provide, as recommended keywords, keywords distributed in a time section corresponding to an access time of the user.

18. The system of claim 17, wherein the analyzer is configured to analyze the use distribution of keywords used for search in the semantic area for each of at least one time section of each day of the week and each time zone of a day.

19. The system of claim 13, wherein the provider is configured to rank and provide keywords used for search in the semantic area.

20. The system of claim 13, wherein the provider is configured to classify keywords used for search in the semantic area into categories, and to rank and provide the categories and category-based keywords.

21. Non-transitory computer-readable media comprising instructions to control a computer system to recommend a keyword, wherein the instructions control the computer system to execute the functions comprising:
redefining a semantic area using a search log comprising location information; and
providing a keyword associated with the semantic area to a user located in the semantic area as a recommended keyword.

22. A file distribution system for distributing a file of an application installed in a user terminal to provide a search service, the file distribution system comprising:
a file transmitter configured to transmit the file in response to a request of the user terminal,
wherein the application comprises:
a module configured to control the user terminal to transmit a keyword recommendation request and a current location to a search server; and
a module configured to control the user terminal to display a recommended keyword provided from the search server in response to the keyword recommendation request,
wherein the search server redefines a semantic area using a search log comprising location information, and provides a keyword associated with the semantic area comprising the current location as the recommended keyword.
